(19) United States
(12) Patent Application Publication
(10) Pub. No.: US 2013/0328774 A1
(43) Pub. Date: Dec. 12, 2013

(54) OPTICAL TOUCH MOUSE

(71) Applicant: PIXART IMAGING INC., Hsin-Chu City (TW)

(72) Inventors: Hui-Hsuan CHEN, Hsin-Chu City (TW); Hung-Ching LAI, Hsin-Chu City (TW)

(21) Appl. No.: 13/909,415

(22) Filed: Jun. 4, 2013

(30) Foreign Application Priority Data
Jun. 8, 2012 (TW) 101120670

(51) Int. Cl. G06F 3/0354

(52) U.S. Cl. CPC G06F 3/03543
USPC 345/158; 345/166

(57) ABSTRACT

An optical touch mouse includes a cover having a portion as a detect window, a lightguide adjacent to the detect window for directing light to the detect window, and a light source adjacent to the lightguide for providing light to enter the lightguide. The detect window is transparent to light provided by the light source such that light provided by the light source can penetrate through the detect window.

### FIELD OF THE INVENTION

The present invention is related generally to an optical input device and, more particularly, to an optical touch mouse.

### BACKGROUND OF THE INVENTION

Covers of computer mice are conventionally made of plastic materials, for example, Acrylonitrile-Butadiene-Styrene (ABS) polyester or Poly-Carbonate (PC), and to enhance their appearance, the plastic materials are mixed with dyes or the covers are spread-coated with dyes to make the covers opaque. In optical touch mouse applications, however, due to the mixed dyes, the opaque cover will reduce the transparency of light for optical sensing, and thereby degrade the sensitivity of the optical sensing. If instead, a transparent or semi-transparent cover is used for an optical touch mouse to increase the transparency of light for optical sensing, the inner circuitry and mechanism of the optical touch mouse will be visible from outside of the optical touch mouse, resulting in a degraded product appearance, and moreover, the outer appearance of the optical touch mouse can not be designed to be colored.

### SUMMARY OF THE INVENTION

An objective of the present invention is to provide an optical touch mouse with an enhanced transparency of light for optical sensing.

Another objective of the present invention is to provide an optical touch mouse allowed to have a colored outer appearance.

According to the present invention, an optical touch mouse includes a cover having a portion as a detect window, a lightguide adjacent to the detect window, and a light source adjacent to the lightguide. The detect window is transparent to light provided by the light source and thus, light provided by the light source can penetrate through the detect window even though the other portion of the cover is opaque.

In this disclosure, “optical touch mouse” is a general term to refer to a device which is able to control a cursor or a pointer (e.g. a highlighted area) by using an optical sensor to sense light change caused by an object interrupting or reflecting light provided by a light source to track change of the object.

### BRIEF DESCRIPTION OF THE DRAWINGS

These and other objectives, features and advantages of the present invention will become apparent to those skilled in the art upon consideration of the following description of the preferred embodiments of the present invention taken in conjunction with the accompanying drawings, in which:

FIG. 1 is a perspective view of a first embodiment according to the present invention;

FIG. 2 is a perspective view of a first embodiment for the lightguide shown in FIG. 1;

FIG. 3 is a perspective view of light scattering by the lightguide shown in FIG. 2;

FIG. 4 is a perspective view of a second embodiment for the lightguide shown in FIG. 1;

FIG. 5 is a perspective view of a third embodiment for the lightguide shown in FIG. 1;

FIG. 6 is a perspective view of a second embodiment according to the present invention; and

FIG. 7 is a perspective view of a third embodiment according to the present invention.

### DETAILED DESCRIPTION OF THE INVENTION

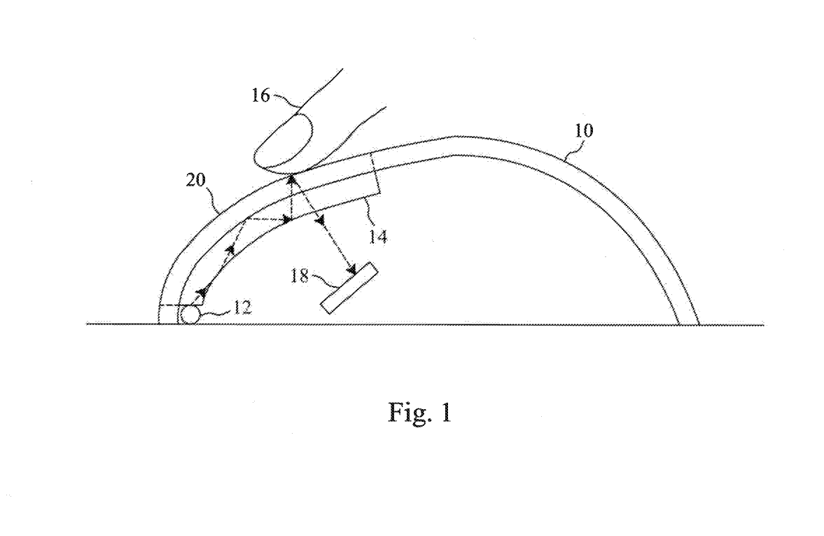

FIG. 1 is a perspective view of a first embodiment according to the present invention, in which an optical touch mouse includes a cover 10 having a portion 20 as a detect window, a lightguide 14 beneath and adjacent to the detect window 20, a light source 12, and an image sensor 18. Preferably, the lightguide 14 is embedded on or attached to the cover 10. The lightguide 14 is preferably a plate and, more preferably, has a curved upper surface conforming to the detect window 20. The light source 12 is preferably adjacent to the lightguide 14 and, more preferably, at one side of the lightguide 14, such that light provided by the light source 12 will enter the lightguide 14 and then propagate within the lightguide 14 by total reflection at the surfaces of the lightguide 14, as shown by the dashed lines and arrows in FIG. 1. The detect window 20 is transparent to light provided by the light source 12, and thus light provided by the light source 12 may penetrate through the detect window 20 from the internal of the optical touch mouse to the external of the optical touch mouse and back from the external of the optical touch mouse to the internal of the optical touch mouse. Preferably, the light source 12 is an invisible light emitting device, for example an infrared (IR) light emitting diode (LED), in which case the cover 10 is made of an IR-pass material, for example a plastic material mixed with a dye transparent to infrared light. Preferably, the other portion of the cover 10 than the detect window 20 contains or is coated with dye (not shown in the figure) which is opaque, i.e. not transparent to visible light, and as a result, light provided by the light source 12 can penetrate only through the detect window 20 to outside of the optical touch mouse, and environmental light external to the optical touch mouse is blocked from passing through the cover 10 to enter the internal of the optical touch mouse to interfere in the operation of the image sensor 18.

It is appreciated that in the present invention, the optical touch mouse is a general term referring to a device utilizing object blocking or reflection of light from a light source for an image sensor to detect light change such that by tracking change of the object, a cursor or a pointer (such as a highlighted area) on a screen can be controlled.

To enhance a portion of light provided by the light source 12 to exist the lightguide 14 to thereby emit toward the detect window 20, one or more surfaces of the lightguide 14 can be disposed of a micro light scattering structure such that, as shown in FIG. 1, when light provided by the light source 12 propagates along the lightguide 14, a portion of the light is totally reflected by the surfaces of the lightguide 14, and the other portion of the light penetrates through the upper surface of the lightguide 14 to reach the detect window 20. In other words, the portion of light provided by the light source 12 that projects onto the micro light scattering structure cannot be totally reflected but passes through the upper surface of the lightguide 14 to project to the detect window 20, and the other portion of the light provided by the light source 12 that does not project onto the micro light scattering structure will still maintain total reflection to propagate within the lightguide 14. If a finger 16 is adjacent to or placed on the detect window 20, the finger 16 will reflect the light that is scattering from the lightguide 14 back to the internal of the optical touch mouse, and thus the image sensor 18 can detect the position of the finger 16 upon the reflected light. Preferably, the size, shape and location of the detect window 20 are so designed to conform to the lightguide 14. The detect window 20 can be arranged at the position of the button part, the roller part or any other parts of the optical touch mouse. The micro light scattering structure is not distributed over the entire surface of the lightguide 14 but cover a certain area ratio of the surface of the lightguide 14, such that light provided by the light source 12 is disturbed partly while maintaining the other portion of the light to be totally reflected to propagate within the lightguide 14.

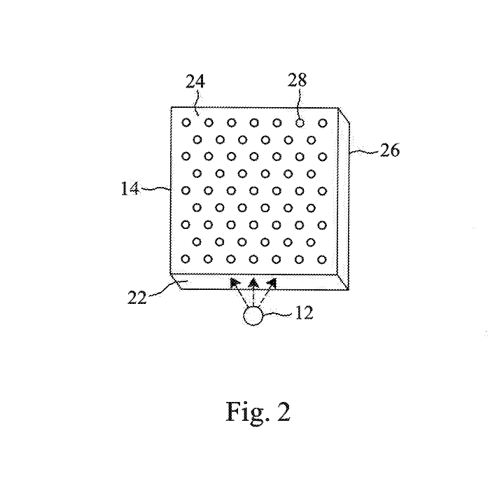

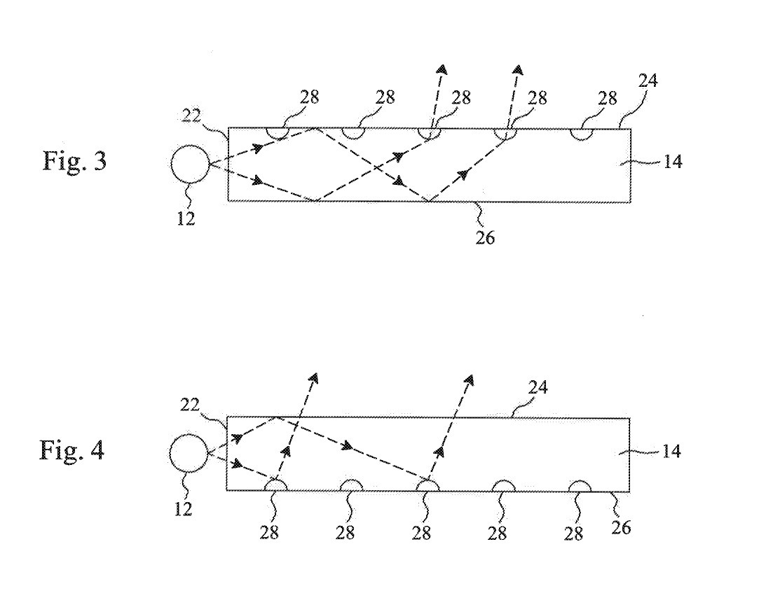

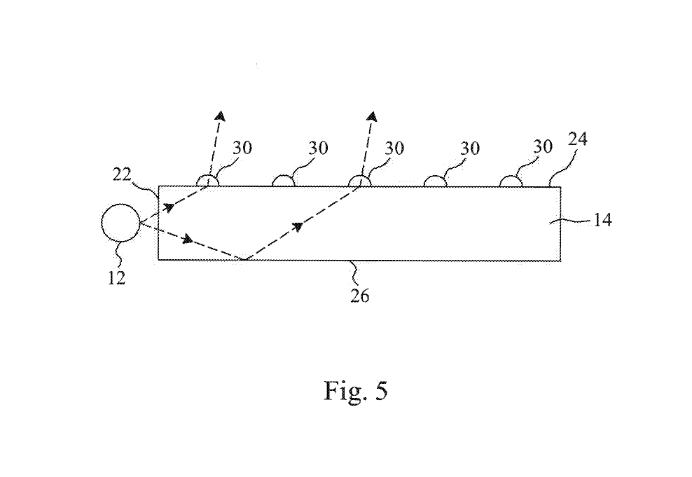

FIG. 2 is a perspective view of a first embodiment for the lightguide 14 shown in FIG. 1, in which the side surface 22 that faces the light source 12 has a reflectivity as low as possible, and the upper surface 24 that faces the detect window 20 is disposed of uniformly distributed dents 28. As shown in FIG. 3, as light provided by the light source 12 enters the lightguide 14, the light is totally reflected at both the upper surface 24 and the lower surface 26 of the lightguide 14; however, due to the dents 28 which destroy total reflection of light at where they are, a portion of the light passes through the upper surface 24. In another embodiment, as shown in FIG. 4, the lower surface 26 of the lightguide 14 is disposed of uniformly disturbed dents 29 such that a portion of the light is reflected by the surface of the dents 28 and passes through the upper surface 24. The lightguides 14 shown in FIG. 3 and FIG. 4 can be integrally formed of the dents 28 during the manufacturing of the lightguide 14, or can be formed of the dents 28 by etching the lightguide 14 after the lightguide 14 is manufactured. The micro light scattering structure can be of a great variety of types, including, for example, bumps, waves, grooves, bubbles or a dye of a certain reflectivity. If a dye is used to form the micro light scattering structure, as the light scattering structure needs to direct light toward the detect window 20, the dye preferably has a reflectivity greater than 20%. FIG. 5 shows an embodiment which forms bumps 30 on the upper surface 24 of the lightguide 14, and this structure can be made during the manufacturing of the lightguide 14 to have the bumps 30 integrally formed, or can be made by printing a light guide material on the upper surface 24 of the lightguide 14 after the lightguide 24 is manufactured. Alternatively, the embodiment shown in FIG. 5 may be modified to form bumps 30 on the lower surface 26 of the lightguide 14. Similarly, for waves or grooves as the micro light scattering structure, they can be integrally formed during the manufacturing of the lightguide 14, or can be made by an etching, printing or pressing process after the lightguide 14 is manufactured. For bubbles as the micro light scattering structure, they can be purposely made during the manufacturing of the lightguide 14.

The above-mentioned light scattering structures can be combined in use, for example, having dents filled with a material to create disturbance of total light reflection within the lightguide 14 to achieve the effect of directing a portion of light towards the detect window 20.

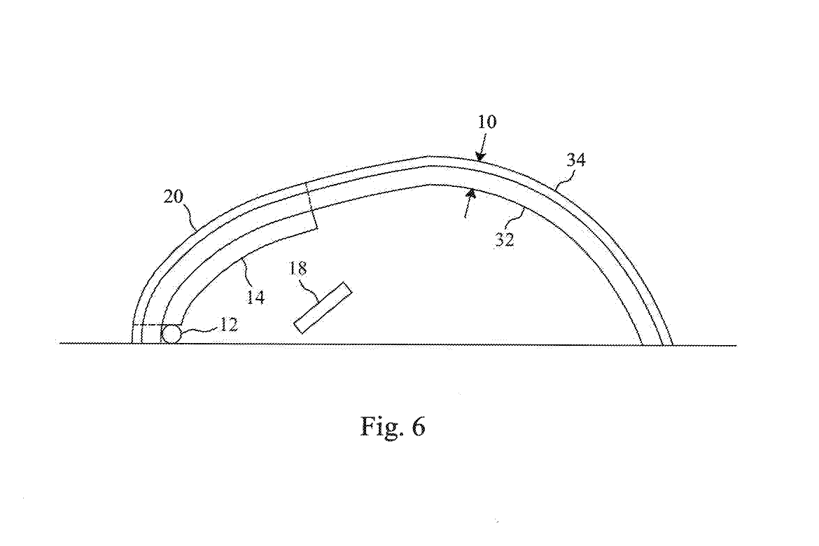

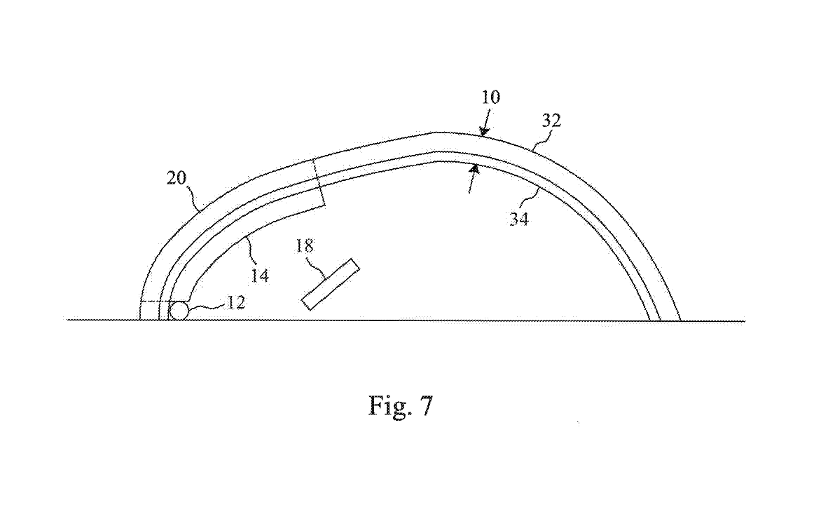

In an embodiment as shown in FIG. 6, the cover 10 of the optical touch mouse includes a transparent base 32 whose outer surface is coated with a dye 34 to make the cover 10 colored, while the dye 34, especially at the detect window 20, is transparent to light provided by the light source 12. Alternatively, as shown in FIG. 7, it can be modified to coat the inner surface of the transparent base 32 with a dye 34 to make the cover 10 colored, while the dye 34, especially at the detect window 20, is transparent to light provided by the light source 12. Preferably, the layer of dye 34 is opaque, i.e. not transparent to visible lights. The outer surface refers to the surface at the outer of the optical touch mouse relative to the structure of the optical touch mouse, which also refers to the surface provided for fingers to touch or place thereon; while the inner surface refers to the one opposite to the outer surface.

Preferably, the outer surface of the cover 10 is treated with a hard coating process to prevent scratches caused by rubbing of fingers thereon.

While the present invention has been described in conjunction with preferred embodiments thereof, it is evident that many alternatives, modifications and variations will be apparent to those skilled in the art. Accordingly, it is intended to embrace all such alternatives, modifications and variations that fall within the spirit and scope thereof as set forth in the appended claims.

What is claimed is:

1. An optical touch mouse comprising:
a cover having a portion as a detect window for touch input;
a lightguide adjacent to said detect window; and
a light source adjacent to said lightguide;
wherein said lightguide and said light source are such arranged that light provided by said light source will enter said lightguide and then have a portion reflected by said lightguide to penetrate through said detect window.

2. The optical touch mouse of claim 1, wherein said cover comprises a. dye transparent to light provided by said light source.

3. The optical touch mouse of claim 1, wherein said cover comprises:
a visually transparent base; and
a layer of dye coated on an outer surface or an inner surface of said visually transparent base, said dye being transparent to light provided by said light source.

4. The optical touch mouse of claim 1, wherein said cover is opaque

5. The optical touch mouse of claim 1, wherein said cover comprises an opaque dye at a second portion of said cover other than said detect window.

6. The optical touch mouse of claim 1, wherein said light source comprises an invisible light emitting device.

7. The optical touch mouse of claim 6, wherein said invisible light emitting device comprises an infrared light emitting diode.

8. The optical touch mouse of claim 1, wherein said lightguide comprises a portion having a micro light scattering structure to destroy total reflection of light provided by said light source.

9. The optical touch mouse of claim 8, wherein said micro light scattering structure comprises dents, bumps, waves, grooves, bubbles or a dye.

10. The optical touch mouse of claim 9, wherein said dye comprises a reflectivity greater than 20%.

11. The optical touch mouse of claim 1, wherein said cover comprises a hard coating on an outer surface of said cover.
